(19) United States
(12) Patent Application Publication
(10) Pub. No.: US 2016/0267496 A1
(43) Pub. Date: Sep. 15, 2016

(54) PROVIDING DYNAMICALLY CONFIGURED OFFERINGS FOR TARGETED MARKETPLACE STORES

(71) Applicant: Microsoft Technology Licensing, LLC, Redmond, WA (US)

(72) Inventors: Yu Zhang, Redmond, WA (US); Swamynathan Subramanian, Redmond, WA (US); Sacrajit Ganguly, Redmond, WA (US); Parisa Delfani, Bellevue, WA (US); Armando Marin, Redmond, WA (US)

(21) Appl. No.: 14/643,764

(22) Filed: Mar. 10, 2015

(51) Int. Cl. G06Q 30/02

(52) U.S. Cl. CPC G06Q 30/0201; G06Q 30/0202

(57) ABSTRACT

Embodiments are directed to defining and implementing a manifest that governs configuration of a targeted marketplace store and to providing customized content offerings in a targeted marketplace store according to a targeted store manifest. In one scenario, a computer system defines a semantics model that includes semantics used to generate a targeted store manifest. The computer system then generates the manifest using the defined semantics model. The manifest includes settings for the content offerings that are to be provided in the targeted marketplace store including an indication of an audience to which the targeted marketplace store is to be deployed. The computer system further interprets the manifest to dynamically deploy a targeted store using the settings specified in the manifest, so that the content offerings provided in the marketplace are customized to the audience indicated in the manifest.

### BACKGROUND

Computing systems have become ubiquitous, ranging from small embedded devices to phones and tablets to PCs and backend servers. Each of these computing systems is designed to process software code. The software allows users to perform functions, interacting with the hardware provided by the computing system. In some cases, these computing systems may be distributed computing systems commonly known as cloud computing systems. These cloud computing systems provide services including marketplace stores. Marketplace stores may include many different types of items including digital content and other offerings. The digital content may include applications (i.e. “apps”), services, media items or other types of digital content.

### BRIEF SUMMARY

Embodiments described herein are directed to defining and implementing a manifest that governs configuration of a targeted marketplace store and to providing customized content offerings in a targeted marketplace store according to a targeted store manifest. In one embodiment, a computer system defines a semantics model that includes multiple semantics used to generate a targeted store manifest. The targeted store manifest defines targeted store settings for content offerings that are to be provided in the targeted marketplace store. The computer system also generates a manifest using the defined semantics model. The manifest includes settings corresponding to the content offerings that are to be provided in the targeted marketplace store including an indication of an audience to which the targeted marketplace store is to be deployed. The computer system further interprets the generated manifest to dynamically deploy a targeted marketplace store using the settings specified in the manifest, so that the content offerings provided in the targeted marketplace are customized to the audience indicated in the manifest. Deploying targeted stores to specific audiences reduces the amount of offerings provided by tailoring those offerings to certain users. This may be more efficient for the consumer, as they only see what is (or is likely to be) most relevant to them, and may also be more efficient for the backend system as it can provide a targeted store with fewer, more tailored offerings to specific consumers.

In another embodiment, a computer system provides customized content offerings in a targeted marketplace store according to a targeted store manifest. accesses a targeted store manifest. The targeted store manifest includes settings corresponding to those portions of content that are to be provided in the targeted marketplace store. The computer system identifies portions of content that are to be included in the targeted marketplace store. This identifying includes mapping the portions of content from a content source to the targeted marketplace store using the settings specified in the targeted store manifest. The computer system filters the identified portions of content based on scopes that apply to the targeted marketplace store according to the settings specified in the targeted store manifest. The computer system further generates at least one content offering based on the filtered portions of content according to the settings included in the targeted store manifest, and provides the generated content offering in the targeted marketplace store.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including defining and implementing a manifest that governs configuration of a targeted marketplace store.

FIG. 2 illustrates a flowchart of an example method for defining and implementing a manifest that governs configuration of a targeted marketplace store.

FIG. 3 illustrates a flowchart of an example method for providing customized content offerings in a targeted marketplace store according to a targeted store manifest.

FIG. 4 illustrates a computer architecture in which embodiments described herein may operate including providing customized content offerings in a targeted marketplace store according to a targeted store manifest.

FIG. 5 illustrates an alternative computer architecture in which a manifest may be defined and implemented which governs configuration of a targeted marketplace store.

### DETAILED DESCRIPTION

Embodiments described herein are directed to defining and implementing a manifest that governs configuration of a targeted marketplace store and to providing customized content offerings in a targeted marketplace store according to a targeted store manifest. In one embodiment, a computer system defines a semantics model that includes multiple semantics used to generate a targeted store manifest. The targeted store manifest defines targeted store settings for content offerings that are to be provided in the targeted marketplace store. The computer system also generates a manifest using the defined semantics model. The manifest includes settings corresponding to the content offerings that are to be provided in the targeted marketplace store including an indication of an audience to which the targeted marketplace store is to be deployed. The computer system further interprets the generated manifest to dynamically deploy a targeted marketplace store using the settings specified in the manifest, so that the content offerings provided in the targeted marketplace are customized to the audience indicated in the manifest.

In another embodiment, a computer system provides customized content offerings in a targeted marketplace store according to a targeted store manifest. accesses a targeted store manifest. The targeted store manifest includes settings corresponding to those portions of content that are to be provided in the targeted marketplace store. The computer system identifies portions of content that are to be included in the targeted marketplace store. This identifying includes mapping the portions of content from a content source to the targeted marketplace store using the settings specified in the targeted store manifest. The computer system filters the identified portions of content based on scopes that apply to the targeted marketplace store according to the settings specified in the targeted store manifest. The computer system further generates at least one content offering based on the filtered portions of content according to the settings included in the targeted store manifest, and provides the generated content offering in the targeted marketplace store.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may implement various types of computing systems. These computing systems are now increasingly taking a wide variety of forms. Computing systems may, for example, be handheld devices such as smartphones or feature phones, appliances, laptop computers, wearable devices, desktop computers, mainframes, distributed computing systems, or even devices that have not conventionally been considered a computing system. In this description and in the claims, the term “computing system” is defined broadly as including any device or system (or combination thereof) that includes at least one physical and tangible hardware processor, and a physical and tangible hardware or firmware memory capable of having thereon computer-executable instructions that may be executed by the processor. A computing system may be distributed over a network environment and may include multiple constituent computing systems.

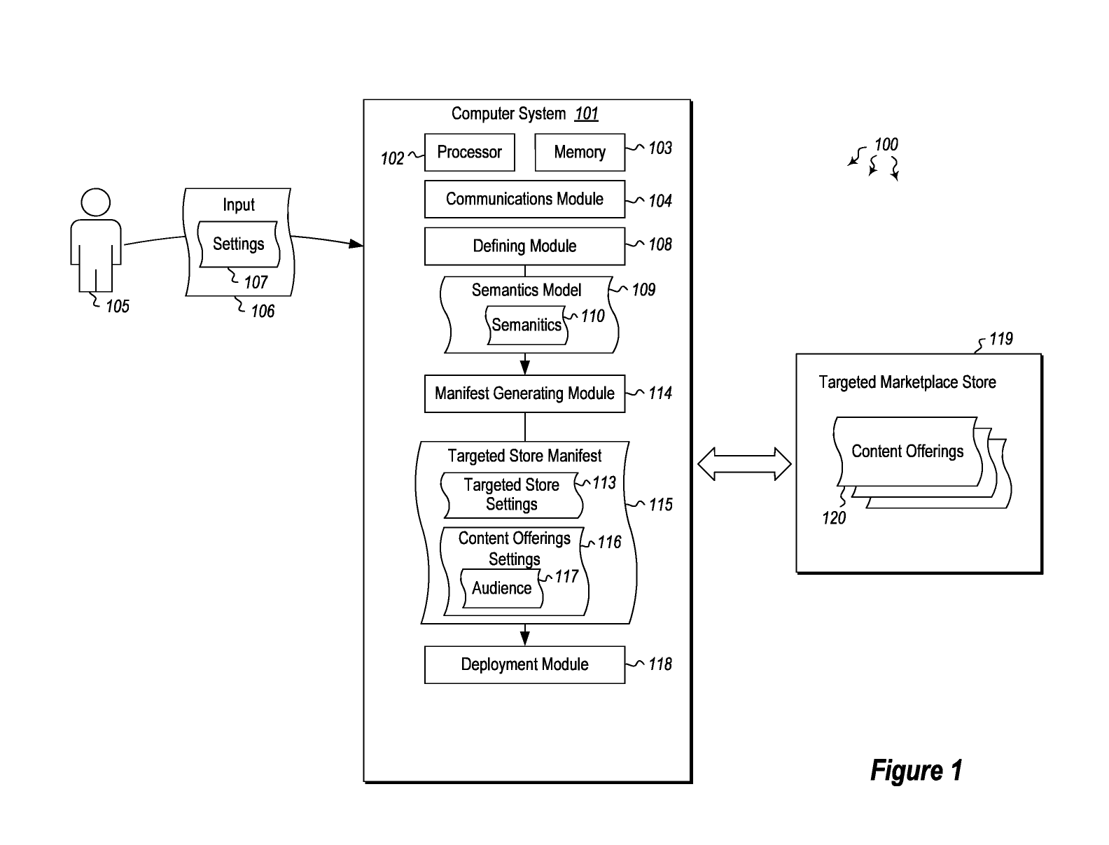

As illustrated in FIG. 1, a computing system 101 typically includes at least one processing unit 102 and memory 103. The memory 103 may be physical system memory, which may be volatile, non-volatile, or some combination of the two. The term “memory” may also be used herein to refer to non-volatile mass storage such as physical storage media or physical storage devices. If the computing system is distributed, the processing, memory and/or storage capability may be distributed as well.

As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media or computer-readable hardware storage devices that form a computer program product. An example of such an operation involves the manipulation of data. The computer-executable instructions (and the manipulated data) may be stored in the memory 103 of the computing system 101. Computing system 101 may also contain communication channels that allow the computing system 101 to communicate with other message processors over a wired or wireless network. Such communication channels may include hardware-based receivers, transmitters or transceivers, which are configured to receive data, transmit data or perform both.

Embodiments described herein may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit 102 over a memory bus in which case the address location is asserted on the memory bus itself. System memory has been traditionally volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media or storage devices that store computer-executable instructions and/or data structures are computer storage media or computer storage devices. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

FIG. 1 illustrates a computer architecture 100 in which at least one embodiment may be employed. Computer architecture 100 includes computer system 101. Computer system 101 may be any type of local or distributed computer system, including a cloud computing system. The computer system 101 includes modules for performing a variety of different functions. For instance, the communications module 104 may be configured to communicate with other computing systems. The communications module 104 may include any wired or wireless communication means that can receive and/or transmit data to or from other computing systems. The communications module 104 may be configured to interact with databases, mobile computing devices (such as mobile phones or tablets), embedded or other types of computing systems.

The computing system 101 includes other modules including the defining module 108. The defining module 108 may be configured to define a semantics model 109. The semantics model 109 may include various semantics 110 that are used to generate a targeted store manifest 115. A targeted store manifest may be used when deploying, configuring or programming a targeted marketplace store (e.g. 119). Indeed, the manifest may include content offering settings 116 that are used when providing content offerings in the targeted marketplace store 119. The content offerings 120 may be displayed within the targeted marketplace store 119. The content offerings 120 may include media content such as music, games, videos or text, or may include software applications or services, or other types of goods. The targeted marketplace store 119 may be configured to provide these content offerings 120 in an intelligent manner, such that certain types of content offerings are provided to certain types of customers or certain persons individually. The targeted marketplace store 119 may be deployed as specified by a user such as an administrative user 105. The administrative user 105 may provide input 106 including settings 107 that are to be used for the targeted marketplace store itself, or for certain content offerings.

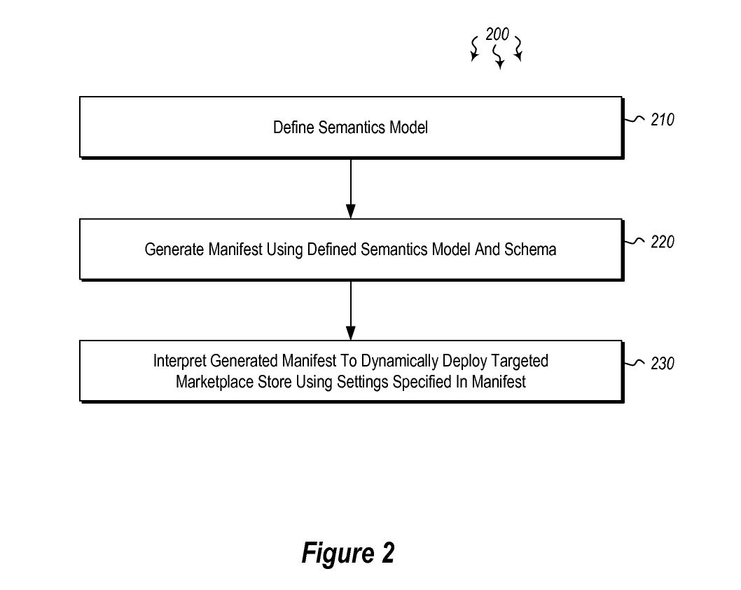

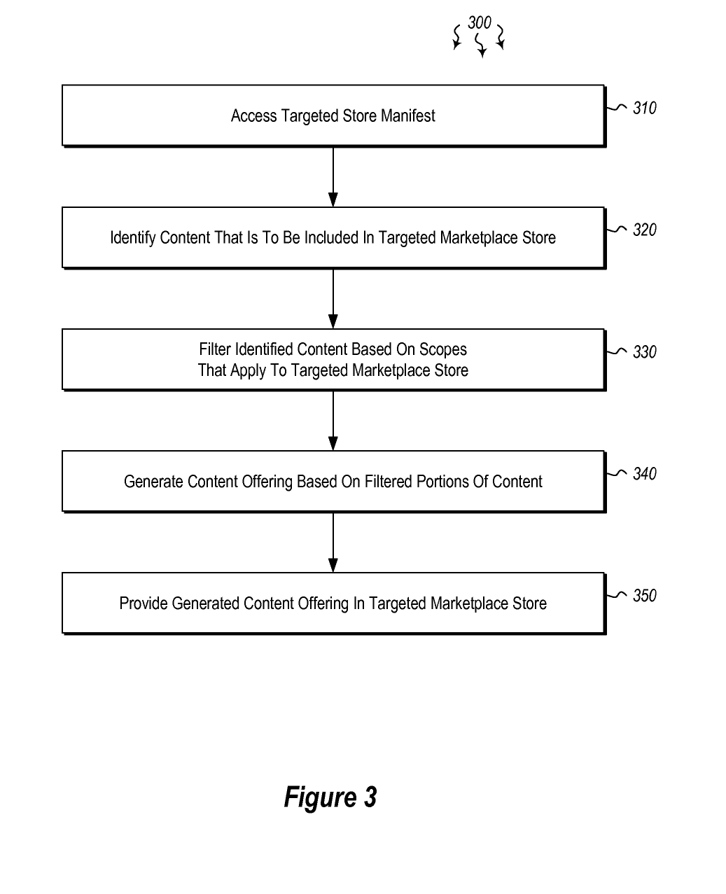

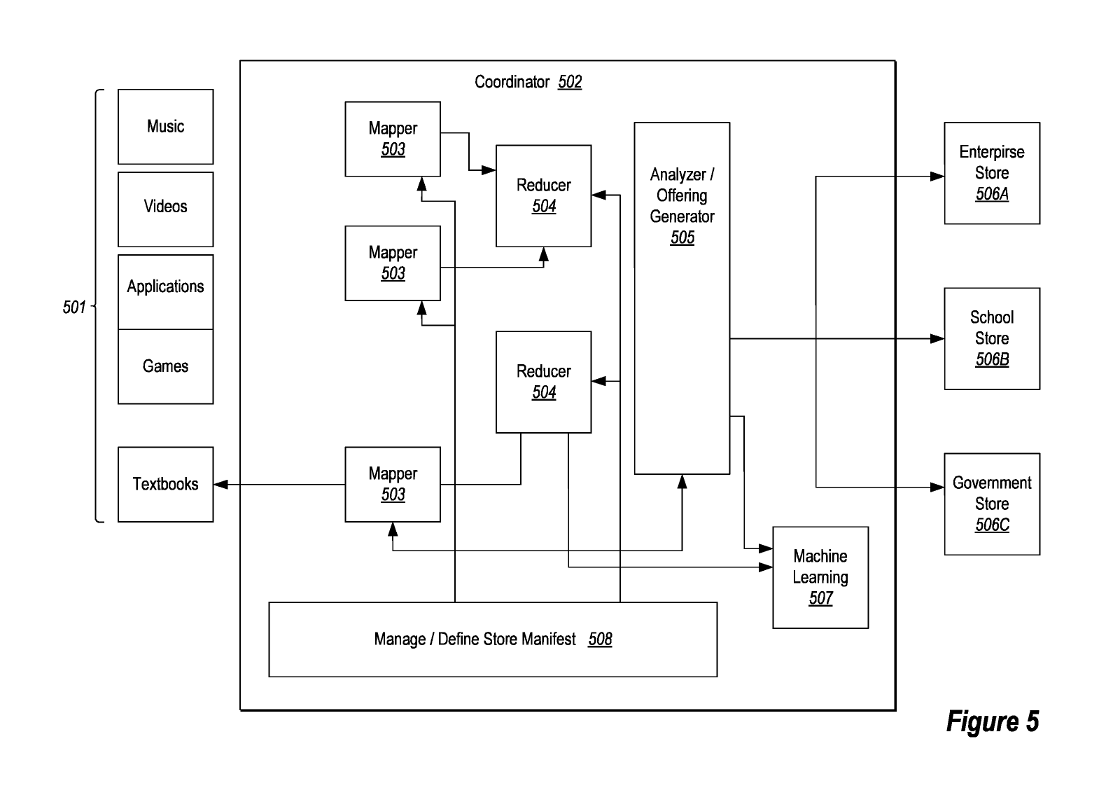

The computer system 101 also includes a targeted store manifest 115. The targeted store manifest 115 may include one or more targeted store settings 113 which are used when deploying the targeted marketplace store 119. The settings may indicate how the store is to appear, functionality the store is to have or other settings that are to be applied to that targeted marketplace store 119. As indicated in the content offerings settings 116, the targeted marketplace store 119 may be targeted to a specific audience 117. The audience may be a single individual, a group of individuals, an entity or entity type or other ordering of persons. Each audience may thus receive its own targeted marketplace store 119 that offers certain types of content at certain prices, with (or without) different types of restrictions. Moreover, the versions of the content offerings provided to each audience may differ per audience. These and other concepts will be introduced below with relation to FIG. 5, and further with regard to methods 200 and 300 of FIGS. 2 and 3, respectively.

Embodiments described herein may be configured to procure digital contents from massive collections, but display them to certain customers using additional constraints or requirements in the business process For example, different types of consumers such as enterprise, education, and government consumers may each have different sets of needs and expectations. Using the embodiments herein, marketplace store providers may bulk purchase content and offer various discounts, distribution methods, and accessibility features to their employees based on their divisions, groups or organizations, or based on other types of access control. In some embodiments, consumers in the educational field can subscribe for retail applications and make them available to targeted grades or different educational departments. Government consumers can procure retail applications and, based on content types or ratings, make them available to federal personnel with different roles or permissions.

The lifecycle of the media and applications provided in the targeted marketplace store 119 may be continually updated and changed. Applications have new versions, prices are changed, availability may be expanded to more countries, availability dates may change, and other changes may occur. As such, these changes are reflected seamlessly and automatically in targeted marketplace stores.

Embodiments may include a system to define business rules and model, as well as an engine to apply them to retail contents dynamically at runtime to provision corresponding content offerings 120 in targeted business stores. For instance, if retail content were to be expanded to more countries, international enterprise employees in those expanded regions would be able to access the retail content substantially immediately through the targeted enterprise store. Similarly, if educational training applications were upgraded from basic level material to advanced material, students in higher grades would be able to access them substantially immediately in the school's targeted marketplace store (e.g. 119).

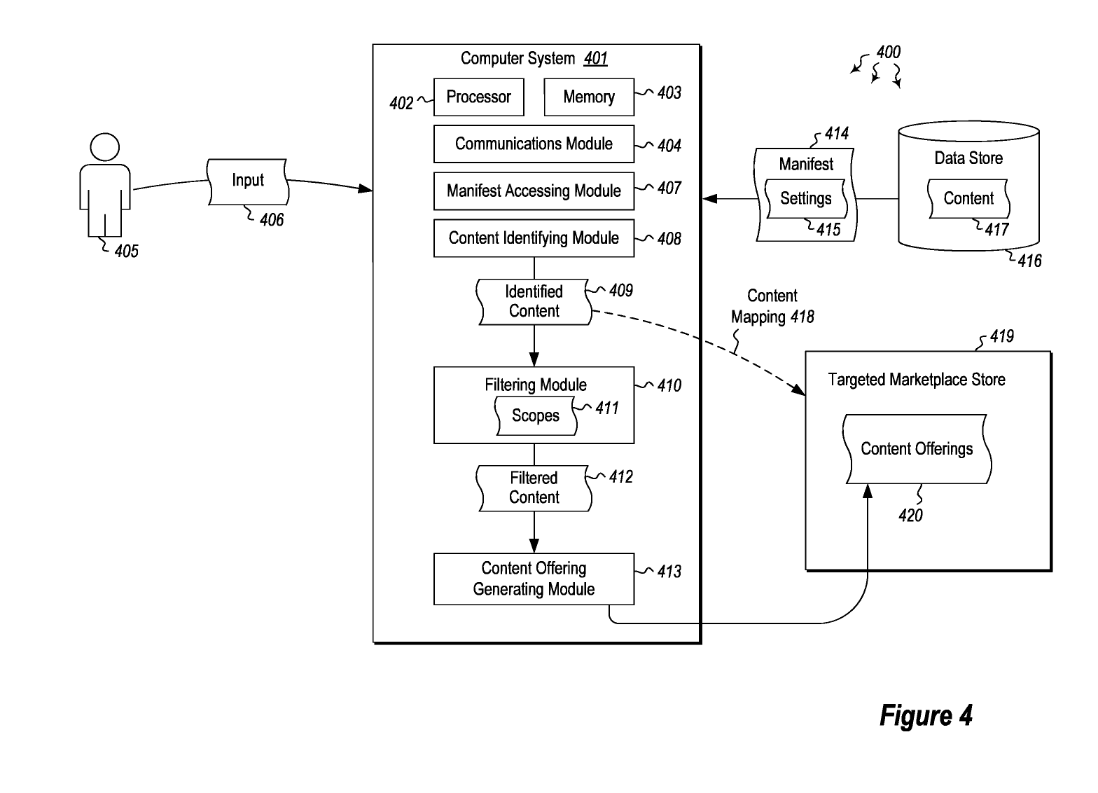

As shown in FIG. 4, the computer system 401 may be configured to define and mange scopes for filtering content to display in the targeted marketplace store 419. The manifest 414 may have settings 415 which indicate the scope of content offerings for each targeted store. Semantics and schemas may be used to define the manifest (as shown in FIG. 1) for a given targeted store. The manifest may define or include settings indicating the intended scope, behavior, audiences, business processes, controls, policies, pricing models, distribution models or other settings.

The scope defines how contents are consumed and distributed. The scope can differ for each content type, accessibility or entity type. For example, internal enterprise IT departments may scope the content offerings to be only approved business-to-business applications in its targeted store. Behaviors may define how targeted application lifecycles are reflected in the targeted store. For example, some enterprises may wish to present specific versions of applications in their targeted store, and not the latest, most updated retail version. The audience setting (i.e. 117) defines managed experiences for content consumption. For instance, teachers may be able to access a retail textbooks application available in the targeted school store for free, while students can get the same application at a discounted price. Business processes, controls or policies can determine how content offerings are provided. For example, enterprise employees may be restricted to consume specific applications from their store if they reside on certain countries based on local law or business policy requirements.

Pricing models may be implemented to determine the ultimate price of each content offering provided to consumers of the targeted marketplace store 119. For example, enterprises may receive a static bulk discount based on an established contract, or educational entities may receive dynamic pricing model to get discount based on run time usage. Distribution models may be implemented to define how retail content is distributed to store consumers. Such distributions may include online or offline distributions, push or pull models or other forms of distribution.

Parsers may be implemented to interpret manifests (e.g. 115). A collection of parsers may be implemented which understands the semantics and translates them into data entities capable of flowing through system. Furthermore, management interfaces may be provided for a store owner or manager or other authority to manage the manifests. The interface may be provided to consumers and/or employers to configure the manifests. Updates to the content offerings are then reflected in real time or are implemented at a scheduled time. An extension interface may also be provided to a customized manifest or parser for specific business needs. An extension of the manifest may also be provided along with a parser as part of framework to support future expansion for new business needs.

In one embodiment, as shown generally in FIG. 5, a system may be implemented to apply business rules or models to configure or generate content offerings dynamically for targeted marketplace stores. A coordinator 502 schedules different workflows (sequential, state machine or custom configured workflows) for content searching, filtering, matching, business processing, offer generating, etc. A mapper 503 dynamically detects, searches or maps contents from various sources through their lifecycles. The lifecycles may include, for example, application updates, version upgrades, platform expansions, pricing changes, country expansions, etc.), based on configured store manifests. A reducer 504 dynamically reduces the matched contents to qualified or scoped contents for targeted stores. For example, education store 506B may categorize textbooks or videos into different grades' catalogs based on age rating, according to store manifests. Other entities such as enterprises 506A or government entities 506C may similarly control the presentation of content (e.g. music, video, games, applications, textbooks, or other content types 501) in the targeted store. A rule analyzer offering generator 505 may look at defined business models, rules, processes, policies, and/or constraints from stores' manifests and dynamically generate content offerings for the targeted stores.

The manage/define store manifest module 508 allows users such as administrators or store managers to manage their targeted stores. For example, enterprises can define retail content to be available automatically to employees in the latest set of countries where content is made available. Or, complex pricing models may be implemented that apply time-based discounts, volume-based discounts, subscription-based discounts or other types of discounts or pricing structures. Various distribution models such as online, offline, push or pull models may be implemented to deliver content offerings. A machine learning module 507 may also be provided to analyze historical collected data and refine, expand, or update business models to adapt to up-to-date content usage. The machine learning module 507 may provide auto-suggest recommendations and/or dynamic channels within the enterprise store based on content usage, trends, user reviews or other feedback. As such, the machine learning module may provide hints as to how the data should be presented to each audience in the targeted marketplace store, according to an analysis of past usage data.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for defining and implementing a manifest that governs configuration and deployment of a targeted marketplace store. Deploying targeted stores to specific audiences in the manner described below may reduce the amount of offerings provided in the store by tailoring those offerings to certain users. This is may reduce network bandwidth as fewer, more targeted offerings may be presented to the user. It may also be more efficient for the backend system as it may consume fewer processing resources when deploying the tailored offerings to specific consumers in the targeted store. The method 200 will now be described with frequent reference to the components and data of environment 100.

Method 200 includes defining a semantics model that includes a plurality of semantics used to generate a targeted store manifest (210). For example, defining module 108 may define semantics model 109 which includes semantics 110 usable to generate targeted store manifest 115. The semantics may include any type of language structure used to determine the relationship between words, signs, symbols, terms or other linguistics structures and their meaning. For instance, the semantics 110 may include rules defining what certain words, symbols or phrases mean within a given semantics model. Then, when this semantics model is used to create a manifest, the meaning of the terms in the manifest is known or may be interpreted using the semantics model 109.

The semantics model 109 may be used to define a targeted store manifest 115. The targeted store manifest may include targeted store settings 113. These settings are applied when the targeted marketplace store 119 is generated. The targeted store settings 113 may include indications of scope for the applications, media items or products offered in the store, behavior of the store including how user interactions are interpreted and implemented, indications of the intended audience of a particular targeted marketplace store, business controls that allow or prevent the display of certain items to certain entities, pricing models that provide a high degree of flexibility and customization, allowing different price structures, discounts, coupons or other offers to be used for different targeted stores, or distribution models that allow targeted marketplace stores to be distributed in online or offline fashions, in push or pull modes or in other modes of distribution. It should be noted that these are just some of the settings that may be included in targeted store settings 113, and that other settings may be input by a user (e.g. 105) as needed.

Additionally or alternatively, the scope setting in the targeted store settings 113 may be used to define how the targeted marketplace store contents 120 are consumed and distributed within the targeted marketplace store 119. In some cases, the scope of the targeted marketplace store settings 113 may differ based on content type, content accessibility, or business specifics. For example, an internal enterprise IT department may use the scope settings to scope contents such that only approved business-to-business applications are provided its targeted marketplace store 119. Similarly, an educational entity may use the scope settings to indicate that only approved scholastic applications are provided in their targeted store.

Pricing models may be applied separately to each targeted marketplace store 119. Pricing models may designate the ultimate price of the content offered to consumers of the targeted store. The pricing models allow each entity or entity type to receive different pricing for the same content offering provided in the targeted marketplace store. For instance, enterprises may receive bulk discounts based on predefined purchase contracts. Educational entities may receive dynamic pricing, such that some consumers receive certain types of discounts (e.g. teachers), while other consumers (e.g. students) receive other discounts or pricing structures. The pricing models may allow for usage discounts based on run time usage or based on a certain number of people downloading the application. In one example, teachers may get certain applications or textbooks for free, while students may need to purchase those applications or textbooks. The distribution models may be implemented to define how retail content is distributed to targeted marketplace store consumers. As mentioned above, the retail content may be distributed to targeted marketplace store consumers online, offline, in a push or pull manner, as a result of a subscription or other event, or in another manner designated by an administrative user.

Method 200 next includes generating a manifest using the defined semantics model, the manifest including one or more settings corresponding to the content offerings that are to be provided in the targeted marketplace store including an indication of an audience to which the targeted marketplace store is to be deployed (220). The manifest generating module 114 generates targeted store manifest 115 using the defined semantics model 109. The manifest 115 may include content offering settings 116 which correspond to the content offerings 120 that are to be provided in the targeted marketplace store 119. The content offering settings 116 may include an indication of intended audience 117 for the targeted marketplace store, as well as other settings that apply specifically to individually items that are to be presented in the store.

Method 200 also includes a step of interpreting the generated manifest to dynamically deploy a targeted marketplace store using the settings specified in the manifest, such that the content offerings provided in the targeted marketplace are customized to the audience indicated in the manifest (230). The deployment module 118 of computer system 101 may be configured to interpret the manifest 115 in order to deploy the targeted marketplace store 119 using the content offering settings 116 specified in the manifest 115. The targeted marketplace store 119 may be deployed on a single computer system or across multiple computer systems in a distributed fashion (such as on the cloud). The deployment and implementation of the targeted marketplace store may involve software, hardware processors, physical memory, updateable firmware and other hardware components.

In some embodiments, one or more parsers are implemented to interpret the generated manifest 115. The parsers may be part of the deployment module 118 which interprets and deploys the targeted marketplace store 119, or may be separate from the deployment module. The parsers may be configured to parse and translate the semantics 110 into a data entity displayable in the targeted marketplace store 119. The data entity may include text, pictures, videos, ratings, reviews, or other media or web content related to a content offering 120.

A management interface may be provided which allows targeted marketplace store owners or managers to manage and configure the manifests which govern how a targeted marketplace store is deployed, configured or programmed. The management interface may be used by user 105 and may be configured to receive and interpret input 106 from the user including settings 107 which the user wishes to have included in the manifest (and hence the targeted marketplace store). When store owners or managers make changes to the manifest, these changes may be reflected in the targeted marketplace store 119 substantially immediately, or may be scheduled for implementation at a specified time. In this manner, targeted marketplace store updates are reflected in real time for the audience specified in the generated manifest, or are scheduled for distribution at a specified time for each audience specified in the manifest 115.

In addition to the management interface, an extension interface may also be provided which allows users to extend any manifests that have been generated, as well as any parsers in the system. The extension interface extends the manifests and the parsers to support future expansion for additional targeted content offerings. In some cases, the deployment module 118 may be configured to categorize content offerings 120 for different audiences based on criteria specified in the manifest. For example, specialized applications may be provided to different departments of an enterprise or government entity. Certain media items may be categorized and provided to students generally, or more specifically, to students enrolled in certain classes. The categorization of content offerings may be controlled by the manifest, and thus by a store owner or manager.

Moreover, the deployment module may provide different levels of content for different users. For example, M rated games may be filtered out for younger consumers, and thus not provided in targeted marketplace stores whose audiences are younger consumers. Still further, the deployment module 118 may be configured to provide content based on usage. As such, certain content offerings 120 may only be presented in the targeted marketplace store if specified usage markers are reached. For instance, once usage of a given application or media item has reached a predefined point, a discount may be applied to that application or media item, or to a similar item. Accordingly, a manifest 115 may be defined and implemented to govern configuration and deployment of a targeted marketplace store 119.

Turning now to FIG. 3, a flowchart is illustrated of a method 300 for providing customized content offerings in a targeted marketplace store according to a targeted store manifest. The method 300 will now be described with frequent reference to the components and data of environment 400 of FIG. 4. Like the computing environment 100 of FIG. 1, environment 400 includes a computer system 401 with hardware components including a processor 402, memory 403 and a communications module 404. Other hardware components such as storage components may also be implemented in the computer system 401.

Method 300 includes accessing a targeted store manifest, the targeted store manifest including one or more settings corresponding to those portions of content that are to be provided in the targeted marketplace store (310). For example, the manifest accessing module 407 of computer system 401 may access manifest 414. The manifest may include settings 415 which correspond to those portions of content 417 that are to be provided in targeted marketplace store 419. The manifest may be stored in data store 416 or in some other data store. Although shown as being outside computer system 401, it will be understood that data store 416 may be some type of magnetic or optical-based storage that is internal to computer system 401. Alternatively, the data store 416 may be an external, distributed storage system including a storage area network (SAN) or cloud-based storage system.

Method 300 next includes identifying one or more portions of content that are to be included in the targeted marketplace store, the identifying including mapping at least one of the portions of content from a content source to the targeted marketplace store using the settings specified in the targeted store manifest (320). The content identifying module 408 may be configured to identify those portions of content 417 that are to be included in the targeted marketplace store 419. As part of this identifying step, the content identifying module 408 may map portions of content from a content source (such as an online bulk data source) to the targeted marketplace store 419 using the settings specified in the manifest 414 (indeed, the manifest 414 may be the same as the manifest 115 described above in conjunction with FIG. 1).

Method 300 also includes filtering the identified portions of content based on one or more scopes that apply to the targeted marketplace store according to the settings specified in the targeted store manifest (330), generating at least one content offering based on the filtered portions of content according to the settings included in the targeted store manifest (340), and providing the at least one generated content offering in the targeted marketplace store (350). The portions of content 409 identified by module 408 may be accessed by the filtering module 410 which filters the content based on scopes 411. The scopes correspond to the targeted marketplace store and are specified in the settings 415 of the manifest 414. The content offering generating module 413 may then generate the content offerings 420 for the targeted marketplace store 419 based on the filtered content portions 412. As such, customized content offerings 420 may be provided in targeted marketplace store 419 according to a targeted store manifest 414.

In some cases, the content offerings 420 may be dynamically procured based on behavior defined in a schema that is included in or is associated with the targeted store manifest. For instance, if a targeted marketplace store is being viewed or used or interacted with in a certain manner by consumers, additional content may be dynamically procured and displayed within the store. If consumers tend to prefer certain products or types of products, additional similar products or items may by dynamically added to the targeted marketplace store 419. Similarly, items may be removed based on behavior defined in the manifest 115. The generated content offerings 420 may be continually updated throughout their lifecycle. When new version or upgrades of an application are released, those new versions may be dynamically procured and added to the targeted marketplace store 419. These new updated versions may be procured and displayed automatically, or may be delayed based on the audience to which the generated content offering is presented. For instance, a store owner or manager may wish to display certain older versions of applications or media items, while waiting to display the most up-to-date version. Moreover, certain application or media item versions may only be shown to certain personnel or groups of persons.

Claims support: a computer system is provided that includes at least one processor. The computer system implements a method for defining and implementing a manifest that governs configuration of a targeted marketplace store, where the method includes: defining a semantics model 109 that includes a plurality of semantics 110 used to generate a targeted store manifest 115, where the manifest defines targeted store settings 113 for one or more content offerings 116 that are to be provided in the targeted marketplace store 119. The method further includes generating the targeted store manifest using the defined semantics model, where the manifest includes one or more settings 116 corresponding to the content offerings that are to be provided in the targeted marketplace store 119 including an indication of an audience 117 to which the targeted marketplace store is to be deployed. The method further includes interpreting the generated manifest 115 to dynamically deploy a targeted marketplace store using the settings specified in the manifest, such that the content offerings 116 provided in the targeted marketplace are customized to the audience indicated in the manifest.

In some cases, the targeted store settings include scope, behavior, audience, business controls, pricing models and/or distribution models. The scope in the targeted store settings defines how targeted marketplace store contents are consumed and distributed within the targeted marketplace store. The scope of the targeted marketplace store settings differs based on content type, content accessibility, or business specifics.

In some embodiments, the pricing models determine the ultimate price of the content offered to consumers of the targeted store. The pricing models allow each entity or entity type to receive different pricing for the same content offering provided in the targeted marketplace store. A set of one or more parsers is implemented to interpret the generated manifest, where the parsers are configured to parse and translate the semantics into a data entity displayable in the targeted marketplace store. The method also includes providing a management interface for targeted marketplace store owners or managers to manage and configure the manifests, and still further provides an extension interface to the at least one generated manifest and at least one parser, where the extension interface extends the manifest and the parser to support future expansion for additional targeted content offerings.

In another embodiment, a computer program product is provided for implementing a method for providing customized content offerings in a targeted marketplace store according to a targeted store manifest. The computer program product comprises one or more computer-readable storage media having stored thereon computer-executable instructions that, when executed by one or more processors of a computing system, cause the computing system to perform the method. The method includes: accessing a targeted store manifest 414, where the targeted store manifest includes one or more settings 415 corresponding to those portions of content that are to be provided in the targeted marketplace store 419, identifying one or more portions of content 417 that are to be included in the targeted marketplace store, where the identifying includes mapping 418 at least one of the portions of content from a content source to the targeted marketplace store using the settings specified in the targeted store manifest, filtering the identified portions of content based on one or more scopes 411 that apply to the targeted marketplace store according to the settings specified in the targeted store manifest, generating at least one content offering 420 based on the filtered portions of content according to the settings 415 included in the targeted store manifest 414, and providing the at least one generated content offering 420 in the targeted marketplace store 419. The content offerings are dynamically procured based on behavior defined in the targeted store manifest. The generated content offering is continually updated throughout its lifecycle.

In another embodiment, a computer system is provided which includes one or more processors, a defining module 108 for defining a semantics model 109 that includes a plurality of semantics 110 used to generate a targeted store manifest 115, where the targeted store manifest defines targeted store settings 113 for one or more content offerings 116 that are to be provided in the targeted marketplace store 119, a manifest generating module 114 for generating the targeted store manifest using the defined semantics model, where the manifest includes one or more settings 116 corresponding to the content offerings that are to be provided in the targeted marketplace store including an indication of an audience 117 to which the targeted marketplace store is to be deployed, and a deployment module 118 for interpreting the generated manifest to dynamically deploy a targeted marketplace store using the settings 113 specified in the manifest, such that the content offerings 116 provided in the targeted marketplace 119 are customized to the audience indicated in the manifest.

The deployment module categorizes content offerings for different audiences based on criteria specified in the manifest. The deployment module also provides content based on usage, such that certain content offerings are only presented in the targeted marketplace store if specified usage markers are reached.

Accordingly, methods, systems and computer program products are provided which define and implement a manifest that governs configuration of a targeted marketplace store. Moreover, methods, systems and computer program products are provided which provide customized content offerings in a targeted marketplace store according to a targeted store manifest.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A method, implemented at a computer system that includes at least one processor, for defining and implementing a manifest that governs configuration of a targeted marketplace store, the method comprising:
defining a semantics model that includes a plurality of semantics used to generate a targeted store manifest, the manifest defining targeted store settings for one or more content offerings that are to be provided in the targeted marketplace store;
generating the targeted store manifest using the defined semantics model, the manifest including one or more settings corresponding to the content offerings that are to be provided in the targeted marketplace store including an indication of an audience to which the targeted marketplace store is to be deployed; and
interpreting the generated manifest to dynamically deploy a targeted marketplace store using the settings specified in the manifest, such that the content offerings provided in the targeted marketplace are customized to the audience indicated in the manifest.

2. The method of claim 1, wherein the targeted store settings include at least one of scope, behavior, audience, business controls, pricing models or distribution models.

3. The method of claim 2, wherein the scope in the targeted store settings defines how targeted marketplace store contents are consumed and distributed within the targeted marketplace store.

4. The method of claim 2, wherein the scope of the targeted marketplace store settings differs based on content type, content accessibility, or business specifics.

5. The method of claim 2, wherein the pricing models determine the ultimate price of the content offered to consumers of the targeted store.

6. The method of claim 5, wherein the pricing models allow each entity or entity type to receive different pricing for the same content offering provided in the targeted marketplace store.

7. The method of claim 2, wherein the distribution models define how retail content is distributed to targeted marketplace store consumers.

8. The method of claim 1, wherein a set of one or more parsers is implemented to interpret the generated manifest, the parsers being configured to parse and translate the semantics into a data entity displayable in the targeted marketplace store.

9. The method of claim 1, further comprising providing a management interface for targeted marketplace store owners or managers to manage and configure the manifests.

10. The method of claim 1, wherein targeted marketplace store updates are reflected in real time for the audience specified in the generated manifest.

11. The method of claim 1, wherein targeted marketplace store updates are scheduled for distribution at a specified time for each audience specified in the generated manifest.

12. The method of claim 1, further comprising providing an extension interface to the at least one generated manifest and at least one parser, the extension interface extending the manifest and the parser to support future expansion for additional targeted content offerings.

13. A computer program product for implementing a method for providing customized content offerings in a targeted marketplace store according to a targeted store manifest, the computer program product comprising one or more computer-readable storage media having stored thereon computer-executable instructions that, when executed by one or more processors of a computing system, cause the computing system to perform the method, the method comprising:
accessing a targeted store manifest, the targeted store manifest including one or more settings corresponding to those portions of content that are to be provided in the targeted marketplace store;
identifying one or more portions of content that are to be included in the targeted marketplace store, the identifying including mapping at least one of the portions of content from a content source to the targeted marketplace store using the settings specified in the targeted store manifest;
filtering the identified portions of content based on one or more scopes that apply to the targeted marketplace store according to the settings specified in the targeted store manifest;
generating at least one content offering based on the filtered portions of content according to the settings included in the targeted store manifest; and
providing the at least one generated content offering in the targeted marketplace store.

14. The computer program product of claim 13, wherein content offerings are dynamically procured based on behavior defined in the targeted store manifest.

15. The computer program product of claim 13, wherein the generated content offering is continually updated throughout its lifecycle.

16. The computer program product of claim 15, wherein specified versions of the generated content offering are displayed based on the audience to which the generated content offering is presented.

17. A computer system comprising the following:
one or more processors;
a defining module for defining a semantics model that includes a plurality of semantics used to generate a targeted store manifest, the targeted store manifest defining targeted store settings for one or more content offerings that are to be provided in the targeted marketplace store;
a manifest generating module for generating the targeted store manifest using the defined semantics model, the manifest including one or more settings corresponding to the content offerings that are to be provided in the targeted marketplace store including an indication of an audience to which the targeted marketplace store is to be deployed; and
a deployment module for interpreting the generated manifest to dynamically deploy a targeted marketplace store using the settings specified in the manifest, such that the content offerings provided in the targeted marketplace are customized to the audience indicated in the manifest.

18. The computer system of claim 17, wherein the deployment module categorizes content offerings for different audiences based on criteria specified in the manifest.

19. The computer system of claim 17, wherein the deployment module provides different levels of content for different users.

20. The computer system of claim 17, wherein the deployment module provides content based on usage, such that certain content offerings are only presented in the targeted marketplace store if specified usage markers are reached.
